(19) United States
(12) Patent Application Publication
(10) Pub. No.: US 2014/0292475 A1
(43) Pub. Date: Oct. 2, 2014

(54) PERSONAL MINI-INTELLIGENT TERMINAL WITH COMBINED VERIFICATION ELECTRONIC LOCK

(71) Applicant: Jun Guo, Nanchang (CN)

(72) Inventor: Jun Guo, Nanchang (CN)

(21) Appl. No.: 14/353,826

(22) PCT Filed: Oct. 31, 2011
(86) PCT No.: PCT/CN2011/081566

§ 371 Date: Apr. 24, 2014

(51) Int. Cl. G07C 9/00

(52) U.S. Cl. CPC G07C 9/00031
USPC 340/5.6

(57) ABSTRACT

The present invention provides a personal mini-intelligent terminal with a combined verification electronic lock, which comprises: a micro-terminal and a locking device. The locking device is connected with the micro-terminal and provided with a mechanical lath. The micro-terminal is locked on a human body or unlocked by the mechanical lath, includes an electronic latch, and is configured to communicate with another uniquely corresponding micro-terminal so as to verify information about each other. When a user sets the micro-terminal to be in a single state, the locking or unlocking of the locking device is controlled by the mechanical latch; and when the user sets the micro-terminal to be in a married or love state and passes the verification, the locking or unlocking of the locking device is controlled by the electronic latch and the mechanical latch together.

### FIELD OF THE INVENTION

The present invention relates to the field of personal mini-intelligent terminals, in particular to a personal mini-intelligent terminal with a combined verification electronic lock.

### BACKGROUND OF THE INVENTION

When the living standards of people are increasingly higher, the emotional lives of people are also increasingly “rich”. On today's society, there is emerging phenomenon that the married party finds another lover on the outside or one party in the love relation is in love with others at the same time. If there is a method or a device for identifying the married state or the love state of concerned parties, the phenomenon can be greatly reduced, which is conducive to the social stability.

At present, the available identities of the above relationships are engagement rings, wedding rings, marriage certificates and the like. But the above identities can be freely worn and hidden by the concerned parties and hence do not have the function of avoiding the above phenomenon at all.

Therefore, a device which not only has the function of identification but also can avoid the random wearing of the concerned parties and hence avoid the case of emotional entanglement due to the concealing or deceiving action of one party is urgently needed currently.

### SUMMARY OF THE INVENTION

The embodiment of the present invention provides a personal mini-intelligent terminal with a combined verification electronic lock, which not only has the function of identification but also can avoid the random wearing of a user and hence can effectively avoid the case of emotional entanglement due to the concealing or deceiving action of one party.

The present invention provides a personal mini-intelligent terminal with a combined verification electronic lock, which comprises a micro-terminal and a locking device. The locking device is connected with the micro-terminal and provided with a mechanical latch. The micro-terminal is locked on a human body or unlocked by the mechanical latch and includes a display, a communication interface, a micro-motor, an electronic latch, a storage device, a battery and a central processing unit (CPU), wherein the display is configured to display information and provided with an emotion display area for displaying the personal emotional state; the personal emotional state includes a single state, a married state and a love state; the storage device is configured to store information; the communication interface is configured to communicate with another uniquely corresponding personal mini-intelligent terminal so as to verify information about each other; the CPU is configured to set the personal emotional state of the display and control the electronic latch to lock or unlock the mechanical latch through the micro-motor according to the verification result; when a user sets the micro-terminal to be in the single state, the locking or unlocking of the locking device is controlled by the mechanical latch; and when the user sets the micro-terminal to be in the married or love state and the verification passes, the locking or unlocking of the locking device is controlled by the electronic latch and the mechanical latch together.

Preferably, in the embodiment of the present invention, the locking device is connected with the micro-terminal through a slide rail; and the CPU drives the electronic latch to lock the slide rail through the micro-motor.

Preferably, in the embodiment of the present invention, the storage device is specifically configured to store an electronic certificate, a fingerprint or a password; and the CPU is configured to verify another electronic lock communicated therewith according to the electronic certificate, the fingerprint or the password.

Preferably, in the embodiment of the present invention, the locking device may be a bracelet, a wristlet, a watchband, a wrister or a chain; and the electronic latch is configured to prop, hitch, jam or hook the mechanical latch through a rotating shaft driven by the micro-motor.

Preferably, in the embodiment of the present invention, the locking device is also provided with a snap fastener which is connected with the micro-motor; when the user sets the micro-terminal to be in the single state, the locking or unlocking of the locking device is controlled by the snap fastener; and when the user sets the micro-terminal to in the married or love state, the locking or unlocking of the locking device is controlled by the electronic latch and the snap fastener together.

Preferably, the personal mini-intelligent terminal comprises a three-color display window for displaying the personal emotional state; the personal emotional state includes a single state, a married state and a love state; three different colors are displayed on the three-color display window to respectively correspond to the single state, the married state and the love state; and the CPU is configured to set the personal emotional state of the three-color display window; and the personal emotional state displayed on the three-color display window is consistent with the personal emotional state displayed on the electronic touch screen.

Preferably, in the embodiment of the present invention, the three-color display window includes a roller wound by three-color labels; the CPU controls the micro-motor to rotate the roller to display corresponding color label on the three-color display window according to the single state, the married state or the love state of the user; or the three-color display window includes three-color light-emitting diode (LED) lamps for respectively displaying three colors to correspond to the single state, the married state and the love state of the electronic touch screen according to the setting of the CPU.

Preferably, in the embodiment of the present invention, the personal mini-intelligent terminal is communicated with another personal mini-intelligent terminal for verification via wireless or wired communication technology, so as to control the locking or unlocking of the electronic latch.

Preferably, the personal mini-intelligent terminal is connected to a network control end of an internet via wireless or wired communication technology; and the network control end is configured to control the locking or unlocking of the locking device under the authority.

Preferably, in the embodiment of the present invention, the micro-terminal includes a mobile phone, an MP3, an MP4, an MP5 or a tablet PC; the display is an electronic touch screen for inputting and displaying information; the battery is a rechargeable battery; and the communication interface is a charging/communication interface for charging and communication with another uniquely corresponding personal mini-intelligent terminal so as to verify information about each other.

As the electronic lock on the personal mini-intelligent terminal provided by the embodiment of the present invention can be locked and unlocked only after matching verification and both parties wearing the personal mini-intelligent terminal, for instance, a couple or lovers, cannot lock or unlock the personal mini-intelligent terminal independently, so that both parties do not need to worry about the case of unauthorized removal and the current personal emotional state can be effectively displayed, and hence the case of emotional entanglement due to the concealing or deceiving action of one party can be avoided.

### BRIEF DESCRIPTION OF THE DRAWINGS

The accompanying drawings illustrated herein are provided for further understanding of the present invention, are one part of the application, and are not intended to limit the present invention. In the accompanying drawings:

FIG. 1 is a schematic structural view of a personal mini-intelligent terminal with a combined verification electronic lock provided by the embodiment of the present invention;

FIG. 2 is a modular structure diagram of the personal mini-intelligent terminal with the combined verification electronic lock provided by the embodiment of the present invention;

FIG. 3 is a using state diagram of the personal mini-intelligent terminal provided by the embodiment of the present invention; and

FIG. 4 is a modular structure diagram of another personal mini-intelligent terminal with a combined verification electronic lock provided by the embodiment of the present invention.

### DETAILED DESCRIPTION OF THE PREFERRED EMBODIMENTS

Clear and complete description will be given below to the technical proposal of the embodiment of the present invention with reference to the accompanying drawings in the embodiment of the present invention. Obviously, the illustrated embodiments are only one part of embodiments of the present invention and not all the embodiments. All the other embodiments obtained by those skilled in the art without creative labor shall fall within the scope of protection of the present invention.

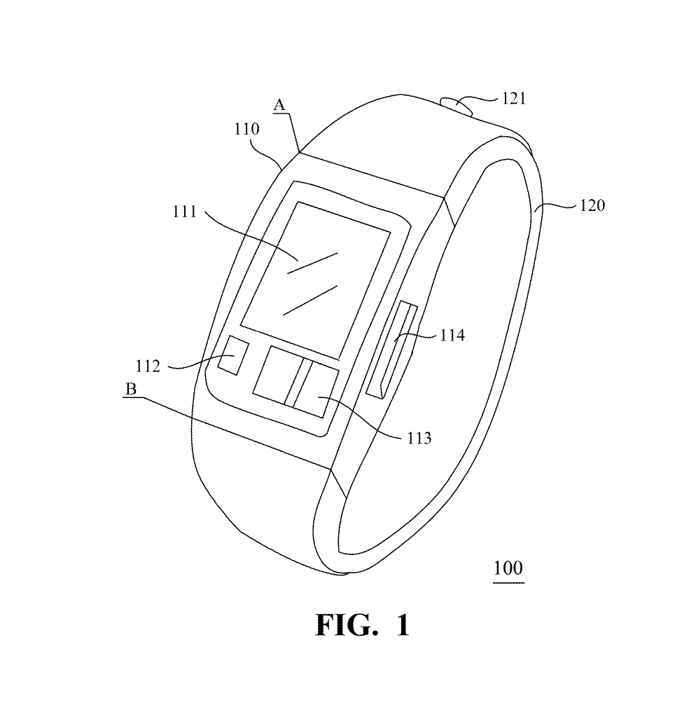

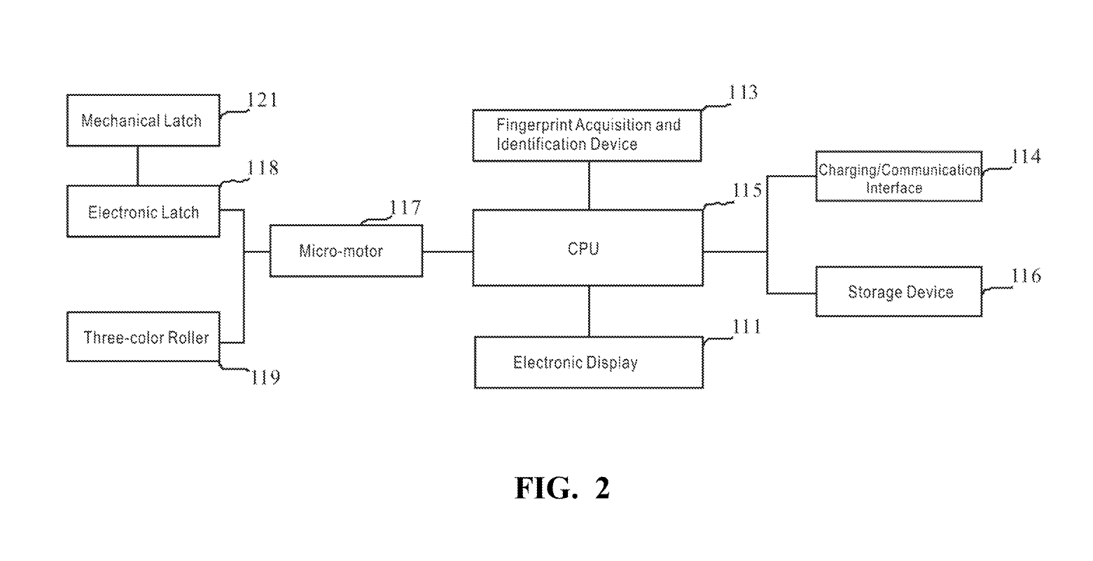

FIG. 1 is a schematic structural view of a personal mini-intelligent terminal with a combined verification electronic lock provided by the embodiment of the present invention, and FIG. 2 is a modular structure diagram of the personal mini-intelligent terminal with the combined verification electronic lock provided by the embodiment of the present invention. As illustrated in FIGS. 1 and 2, the personal mini-intelligent terminal 100 comprises a micro-terminal 110 and a locking device 120. The locking device 120 is connected with the micro-terminal 110 and configured to lock the personal mini-intelligent terminal 100 on a human body. In the embodiment, the micro-terminal 110, for instance, may be a micro-terminal with operation processing function such as a mobile phone, an MP3, an MP4, an MP5 and a tablet PC, and the locking device 120 may be an article capable of being fixed on the human body such as a bracelet, a wristlet, a watchband and a chain.

The micro-terminal 110 includes a CPU 115, a micro-motor 117, an electronic latch 118 and a charging/communication interface 114, wherein the CPU 115 is respectively connected with the charging/communication interface 114 and the micro-motor 117; and the electronic latch 118 is connected with the micro-motor 117.

As illustrated in FIG. 1, the electronic latch 118 is disposed at a connected position of the micro-terminal 110 and the locking device 120. For instance, at an A position or a B position as shown in FIG. 1, the electronic latch 118 may be driven by the micro-motor 117 to lock or unlock the locking device 120.

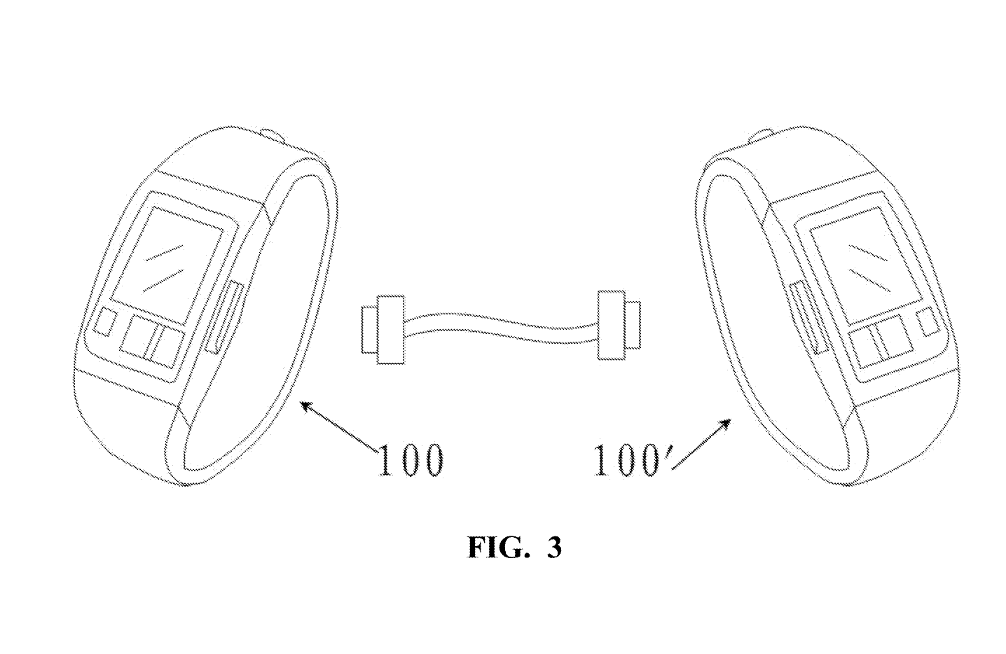

The charging/communication interface 114 may be a data line interface, e.g., a USB interface. The personal mini-intelligent terminal 100 in the embodiment may be communicated with another uniquely corresponding personal mini-intelligent terminal 100′ for wired data transmission through the charging/communication interface 114, and hence verifies information about each other (as shown in FIG. 3). The CPU 115 may control the micro-motor 117 to drive the electronic latch 118 to lock or unlock the locking device 120 according to the verification result. More specifically, when a pair of lovers or a couple consult with each other to wear the personal mini-intelligent terminals 100 and 100′ provided by the embodiment, the personal mini-intelligent terminals 100 and 100′ must be connected with each other through a data line at first and hence achieve mutual verification; when the verification result passes, the CPU 115 automatically controls the locking of the electronic latch 118; and in the case of unlocking required, the personal mini-intelligent terminals 100 and 100′ must also be connected with each other through the data line and hence achieve mutual verification, and the CPU 115 sends out an unlocking command to control the unlocking of the electronic latch 118 only after the verification passes.

There are various verification modes between the personal mini-intelligent terminals 100, for instance, fingerprint verification, electronic certificate verification and password verification. The embodiment of the present invention may adopt one or more verification modes. Correspondingly, the personal mini-intelligent terminal provided by the embodiment of the present invention may further comprise a storage device 116 for storing information such as an electronic certificate, a fingerprint or a password. When the fingerprint verification mode is adopted, a fingerprint acquisition and identification device may be disposed on the micro-terminal 110. When the personal mini-intelligent terminals 100 and 100′ are connected, both parties perform fingerprint verification respectively; and after the verification passes, the personal mini-intelligent terminals 100 and 100′ are locked or unlocked simultaneously. When electronic certificates are adopted for verification, after the personal mini-intelligent terminals 100 and 100′ are connected, the personal mini-intelligent terminals 100 and 100′ send the respective prestored electronic certificates to each other and verify the validity of the electronic certificates by each other; and if both the electronic certificates pass the verification, the personal mini-intelligent terminals 100 and 100′ are locked or unlocked simultaneously. The case of password verification mode is similar to the case of fingerprint verification mode. No further description will be given here.

As an embodiment of the present invention, the connection between the locking device 120 and the micro-terminal 110 may be separable connection and may also be inseparable fixed connection. In the case of separable connection, the locking device 120 may be connected with the micro-terminal 110 through a slide rail, and the CPU 115 may drive the electronic latch 118 to lock the slide rail through the micro-motor 117. In the embodiment, the slide rail, for instance, may be disposed at the B position as shown in FIG. 1. Of course, in the embodiment of the present invention, both the A position and the B position may adopt the slide rail design. No limitation will be given here to the present invention. As the connection between the locking device 120 and the micro-terminal 110 is separable, only the micro-terminal 110 may be updated along with the development of science and technology subsequently.

As an embodiment of the present invention, the surface of the locking device 120 may also be provided with a mechanical latch 121 which is connected with the electronic latch 118. By adoption of the mechanical latch 121, the personal mini-intelligent terminal 100 provided by the embodiment is also applicable to use in the single state and may be taken as an ornament or a functional device. More specifically, when the user sets the personal mini-intelligent terminal 100 to be in the single state, the locking or unlocking of the locking device 120 is controlled by the mechanical latch 121, namely the locking device 120 can be locked or unlocked when the user presses the mechanical latch 121 independently; and when the user sets the personal mini-intelligent terminal 100 to be in the married or love state, the locking or unlocking of the locking device 120 is controlled by the electronic latch 118 and the mechanical latch 121 together, namely the mechanical latch 121 must be coordinated with the mechanical latch 118 to control the locking or unlocking of the locking device 120 together.

As another embodiment of the present invention, the mechanical latch on the locking device 120 may also be replaced by a snap fastener (not shown). The snap fastener is connected with the micro-motor 117. When the user sets the personal mini-intelligent terminal 100 to be in the single state, the locking or unlocking of the locking device 120 is controlled by the snap fastener; and when the user sets the personal mini-intelligent terminal 100 to be in the married or love state, the locking or unlocking of the locking device 120 is controlled by the electronic latch 118 and the snap fastener together.

As an embodiment of the present invention, the locking device 120 may also be provided with a three-color display window 112 for displaying the current user state. The state includes a single state, a married state and a love state. The three-color display window 112 may be provided with a three-color roller 119. The three-color roller 119 may be formed by three-color labels wound on a roller. The three-color labels correspond to the three user states respectively. The three-color roller 119 is connected with the micro-motor 117, so that the CPU 115 may control the three-color display window to display corresponding color label according to the single state, the married state or the love state of the user, and hence the user state is obvious and others can have a general understanding of the situation of the user. Therefore, various phenomena illustrated in the prior art caused by unawareness of some people can be avoided.

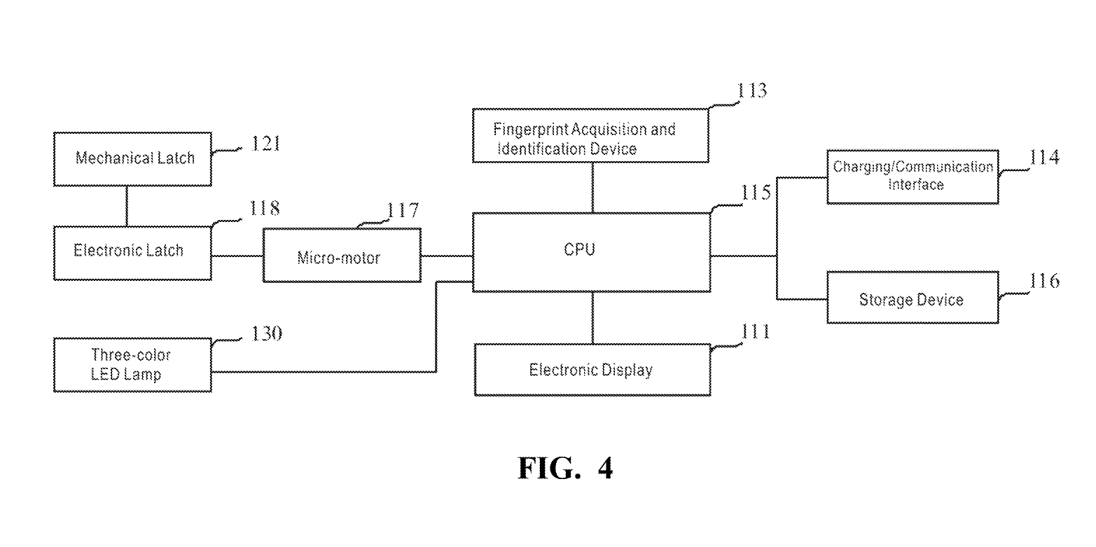

As another embodiment of the present invention, the three-color display window 112 may also be provided with three-color LED lamps 130. As illustrated in FIG. 4, a control button (not shown) may also be arranged corresponding to the three-color LED lamps 130. The control button may be formed by a navigation key on the micro-terminal 110. The three-color LED lamps 130 are connected with the CPU 115. When the control button is pressed, the LED lamp corresponding to the current user state is displayed on the three-color display window 112. It should be noted that the connection between the locking device 120 and the micro-terminal 110 is more applicable to be separable when the setting mode is adopted.

As an embodiment of the present invention, the micro-terminal 110 also includes an electronic display 111 for displaying relevant verification information and user information, for instance, may display whether the verification has passed and whether the user is in the single state, the married state or the love state. Moreover, the electronic display 111 may also display entertainment information such as songs and videos.

The personal mini-intelligent terminal 100 provided by the embodiment of the present invention not only can achieve locking and unlocking after matching verification but also can achieve locking and unlocking through a network control end. More specifically, the personal mini-intelligent terminals 100 of both parties may be connected to a computer through the charging/communication interface 114 and hence connected to the network control end through the computer. The network control end may lock and unlock the electronic lock remotely according to the authorization of both parties. Or in the case of unexpected conditions, e.g., damage, missing or the case that one party does not agree with unlocking, the personal mini-intelligent terminal 100 may also be unlocked by the network control end authorized by the wearer, but cannot be authorized to be locked. In the case of authorized locking, both parties must authorize simultaneously.

Moreover, the charging/communication interface 114 may also have charging function and may be configured to charge the personal mini-intelligent terminal 100 by being connected with a charger.

Finally, the personal mini-intelligent terminal 100 provided by the embodiment of the present invention also has the waterproof function so as to ensure that the personal mini-intelligent terminal 100 can be normally applied in daily life. The waterproof technology can refer to the prior art. For instance, waterproof seals are disposed at hermetical positions of important parts. No further description will be given here.

As the personal mini-intelligent terminal provided by the embodiment of the present invention can be locked and unlocked only after matching verification and both parties wearing the personal mini-intelligent terminal, for instance, a couple or lovers, cannot lock and unlock the personal mini-intelligent terminal independently, both parties do not need to worry about the case of unauthorized removal of one party, so that the current personal emotional state can be effectively displayed, and hence the case of emotional entanglement due to the concealing or deceiving action of one party can be effectively avoided.

The objectives, technical proposals and advantages of the present invention have been described above in detail with reference to the preferred embodiments. It should be understood that the foregoing is only the preferred embodiments of the present invention and not intended to limit the scope of protection of the present invention. Any modification, equivalent replacement, improvement and the like made within the spirit and principle of the present invention should fall within the scope of protection of the present invention.

What is claimed is:

1. A personal mini-intelligent terminal with a combined verification electronic lock, comprising a micro-terminal and a locking device, the locking device connected with the micro-terminal and provided with a mechanical latch, the micro-terminal locked on a human body or unlocked by the mechanical latch and including a display, a communication interface, a micro-motor, an electronic latch, a storage device, a battery and a central processing unit (CPU), wherein the display is configured to display information and provided with an emotion display area for displaying the personal emotional state; the personal emotional state includes a single state, a married state and a love state; the storage device is configured to store information; the communication interface is configured to communicate with another uniquely corresponding personal mini-intelligent terminal so as to verify information about each other; the CPU is configured to set the personal emotional state of the display and control the electronic latch to lock or unlock the mechanical latch through the micro-motor according to the verification result; when a user sets the micro-terminal to be in the single state, the locking or unlocking of the locking device is controlled by the mechanical latch; and when the user sets the micro-terminal to be in the married or love state and the verification passes, the locking or unlocking of the locking device is controlled by the electronic latch and the mechanical latch together.

2. The personal mini-intelligent terminal with the combined verification electronic lock according to claim 1, wherein the locking device is connected with the micro-terminal through a slide rail; and the CPU drives the electronic latch to lock the slide rail through the micro-motor.

3. The personal mini-intelligent terminal with the combined verification electronic lock according to claim 1, wherein the storage device is specifically configured to store an electronic certificate, a fingerprint or a password; and the CPU is configured to verify another electronic lock communicated therewith according to the electronic certificate, the fingerprint or the password.

4. The personal mini-intelligent terminal with the combined verification electronic lock according to claim 1, wherein the locking device may be a bracelet, a wristlet, a watchband, a wrister or a chain; and the electronic latch is configured to prop, hitch, jam or hook the mechanical latch through a rotating shaft driven by the micro-motor.

5. The personal mini-intelligent terminal with the combined verification electronic lock according to claim 1, wherein the locking device is also provided with a snap fastener which is connected with the micro-motor; when the user sets the micro-terminal to be in the single state, the locking or unlocking of the locking device is controlled by the snap fastener; and when the user sets the micro-terminal to in the married or love state, the locking or unlocking of the locking device is controlled by the electronic latch and the snap fastener together.

6. The personal mini-intelligent terminal with the combined verification electronic lock according to claim 1, wherein the personal mini-intelligent terminal comprises a three-color display window for displaying the personal emotional state; the personal emotional state includes a single state, a married state and a love state; three different colors are displayed on the three-color display window to correspond to the single state, the married state and the love state respectively; and the CPU is configured to set the personal emotional state of the three-color display window; and the personal emotional state displayed on the three-color display window is consistent with the personal emotional state displayed on the electronic touch screen.

7. The personal mini-intelligent terminal with the combined verification electronic lock according to claim 6, wherein
the three-color display window includes a roller wound by three-color labels; the CPU controls the micro-motor to rotate the roller to display corresponding color label on the three-color display window according to the single state, the married state or the love state of the user;
or the three-color display window includes three-color light-emitting diode (LED) lamps for respectively displaying three colors to correspond to the single state, the married state and the love state of the electronic touch screen according to the setting of the CPU.

8. The personal mini-intelligent terminal with the combined verification electronic lock according to claim 1, wherein the personal mini-intelligent terminal is communicated with another personal mini-intelligent terminal for verification via wireless or wired communication technology, so as to control the locking or unlocking of the electronic latch.

9. The personal mini-intelligent terminal with the combined verification electronic lock according to claim 1, wherein the personal mini-intelligent terminal is connected to a network control end of an internet via wireless or wired communication technology; and the network control end is configured to control the locking or unlocking of the locking device under the authority.

10. The personal mini-intelligent terminal with the combined verification electronic lock according to claim 1, wherein the micro-terminal includes a mobile phone, an MP3, an MP4, an MP5 or a tablet PC; the display is an electronic touch screen for inputting and displaying information; the battery is a rechargeable battery; and the communication interface is a charging/communication interface for charging and communication with another uniquely corresponding personal mini-intelligent terminal so as to verify information about each other.
